(19) United States
(12) Patent Application Publication
(10) Pub. No.: US 2026/0135748 A1
(43) Pub. Date: May 14, 2026

(54) Methods And Apparatus For Determining Channel Information Based On Reference Signal Types In Mobile Communications

(71) Applicant: MediaTek Inc., Hsinchu City (TW)

(72) Inventor: Chien-Hwa Hwang, Hsinchu City (TW)

(73) Assignee: MediaTek Inc., Hsinchu City (TW)

(21) Appl. No.: 19/373,790

(22) Filed: Oct. 30, 2025

Related U.S. Application Data
(60) Provisional application No. 63/720,240, filed on Nov. 14, 2024.

(51) Int. Cl. H04L 27/26; H04B 17/318; H04L 5/00

(52) U.S. Cl. CPC H04L 27/261; H04B 17/328; H04L 5/0048

(57) ABSTRACT

Various solutions for determining channel information based on reference signal types with respect to an apparatus in mobile communications are described. The apparatus may determine a first metric and a second metric according to a first type of reference signals and a second type of reference signals respectively. The apparatus may compare the first metric with the second metric. The apparatus may determine channel information based on at least one of the first type of reference signals and the second type of reference signals according to a result of comparing the first metric with the second metric.

### CROSS REFERENCE TO RELATED PATENT APPLICATION(S)

The present disclosure is part of a non-provisional application claiming the priority benefit of U.S. Patent Application No. 63/720,240, filed on 14 Nov. 2024, the content of which herein being incorporated by reference in its entirety.

### TECHNICAL FIELD

The present disclosure is generally related to mobile communications and, more particularly, to determining channel information based on reference signal types with respect to apparatus in mobile communications.

### BACKGROUND

Unless otherwise indicated herein, approaches described in this section are not prior art to the claims listed below and are not admitted as prior art by inclusion in this section.

In Long-Term Evolution (LTE) or New Radio (NR) mobile communications, reference signals (RSs) may be transmitted by a network node to enable a user equipment (UE) to perform channel acquisition and estimation. The UE may derive channel state information (CSI) for coherent demodulation and beamforming based on the RSs. Although this approach may ensure reliable estimation accuracy, it may require dense pilot placement occupying more resources (e.g., time and/or frequency resources) and consequently introduce significant signaling and resource overhead.

To reduce signaling and resource overhead while maintaining sufficient channel estimation accuracy, compressed sensing (CS) techniques have been introduced for channel acquisition. In CS-based channel sensing, a network node may transmit reference signals designed according to compressed sensing principles, and a user equipment (UE) may estimate or reconstruct channel-related information based on the received signals. Such techniques may enable the acquisition of essential channel characteristics with a reduced number of measurements compared to conventional pilot-based approaches, thereby enhancing overall system efficiency.

However, in some network scenarios, the performance of CS may become less reliable. Since CS techniques generally rely on the sparsity and stable recovery of channel information from limited measurements, factors such as insufficient sparsity or low signal quality may result in degraded estimation performance. Consequently, the overall system throughput, beamforming gain, or link reliability may be adversely affected.

Accordingly, balancing channel-estimation reliability and system overhead becomes an important issue in the newly developed wireless communication network. Therefore, there is a need to provide proper schemes to balance channel-estimation reliability and system overhead.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to determining channel information based on reference signal types with respect to apparatus in mobile communications.

In one aspect, a method may involve an apparatus determining a first metric and a second metric according to a first type of reference signals and a second type of reference signals respectively. The method may also involve the apparatus comparing the first metric with the second metric. The method may further involve the apparatus determining channel information based on at least one of the first type of reference signals and the second type of reference signals according to a result of comparing the first metric with the second metric.

In one aspect, a method may involve an apparatus determining a first type of reference signals and a second type of reference signals. The method may also involve the apparatus transmitting the first type of reference signals and the second type of reference signals for determining a first metric and a second metric according to the first type of reference signals and the second type of reference signals.

In one aspect, an apparatus may comprise a transceiver which, during operation, wirelessly communicates with a wireless network. The apparatus may also comprise a processor communicatively coupled to the transceiver. The processor, during operation, may perform operations comprising determining a first metric and a second metric according to a first type of reference signals and a second type of reference signals respectively. The processor may also perform operations comprising comparing the first metric with the second metric. The processor may further perform operations comprising determining channel information based on at least one of the first type of reference signals and the second type of reference signals according to a result of comparing the first metric with the second metric.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a block diagram of an example communication system in accordance with an implementation of the present disclosure.

FIG. 5 is a flowchart of an example process in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to determining channel information based on reference signal types with respect to apparatus in mobile communications. According to the present disclosure, a number of possible solutions may be implemented separately or jointly. That is, although these possible solutions may be described below separately, two or more of these possible solutions may be implemented in one combination or another.

Regarding the present disclosure, a network node may determine a first type of reference signals and a second type of reference signals. The network node may transmit the first type of reference signals and the second type of reference signals. Based on two types of reference signals, a User Equipment (UE) may determine: (1) a first metric according to the first type of reference signals and (2) a second metric according to the second type of reference signals. The UE may compare the first metric with the second metric. According to a result of comparing the first metric with the second metric, the UE may determine channel information based on at least one of the first type of reference signals and the second type of reference signals.

Accordingly, based on a comparison between the first metric and the second metric, the UE may determine an appropriate type of reference signals for subsequent channel estimation, thereby achieving a balance between channel-estimation reliability and system overhead.

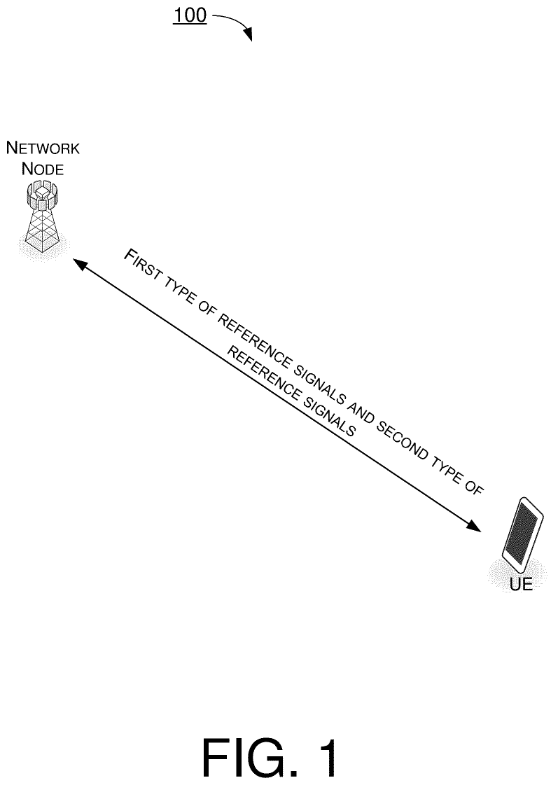

FIG. 1 illustrates an example scenario 100 under schemes in accordance with implementations of the present disclosure. Scenario 100 involves a network side and one or more UEs, which may be a part of a wireless communication network (e.g., an LTE network, a 5G/NR network, an IoT network or a 6G network). Scenario 100 illustrates the current network framework. The UEs may connect to the network side. The network side may comprise one or more than one network nodes. For illustrative purposes, one network node and one UE may be described hereinafter. However, it is not intended to limit the network scenarios of the present disclosure.

In some embodiments, the network node may determine a first type of reference signals and a second type of reference signals. In some implementations, the first type of reference signals may be associated with compressed sensing. In particular, the first type of reference signals may be utilized for compressed sensing-based channel acquisition, in which the UE may reconstruct sparse or compressible channel coefficients from a reduced number of measurements. By exploiting the inherent sparsity of wireless propagation paths, the first type of reference signals may enable accurate estimation of dominant channel components with significantly fewer pilot resources, thereby improving spectral efficiency and reducing signaling overhead. Regarding the first type of reference signals, reliable reconstruction may depend on sufficient sparsity and a relatively high signal-to-noise ratio (SNR).

More specifically, in compressed sensing, the channel acquisition process may be formulated as an underdetermined linear measurement model y=Φh+e, where Φ denotes a sensing matrix determined by the transmit and receive sensing codebooks, h represents the sparse or compressible channel vector, and e denotes noise. The UE may recover h by solving an [symbol] ₁-norm minimization or greedy approximation problem such as orthogonal matching pursuit (OMP), subject to measurement error constraints. Reliable recovery may be guaranteed when the sensing matrix satisfies the restricted isometry property (RIP), ensuring that all K-sparse channel vectors are approximately preserved in Euclidean distance. Accordingly, accurate channel reconstruction may be achieved with a number of measurements proportional to O(KlogN), thereby substantially reducing pilot signaling overhead while maintaining estimation accuracy.

In some implementations, the second type of reference signals may be associated with normal reference signals. In particular, the second type of reference signals may be associated with conventional pilot-based reference signals transmitted in a predetermined orthogonal pattern to acquire complete channel information. The second type of reference signals may provide robust and stable channel estimation performance even under non-sparse or low-SNR conditions.

In some cases, since all pilot resources may be utilized for exhaustive measurement, the second type of reference signals may incur higher overhead compared to the first type of reference signals. In some cases, the second type of reference signals may provide higher reliability compared to the first type of reference signals.

In some implementations, the network node may transmit the first type of reference signals and the second type of reference signals to the UE. The UE may receive the first type of reference signals and the second type of reference signals from the network node. Based on two types of reference signals, the UE may determine: (1) a first metric according to the first type of reference signals and (2) a second metric according to the second type of reference signals. In some cases, each of the first metric and the second metric may include Channel Quality Indicator (CQI) or Reference Signal Received Power (RSRP).

In some implementations, the UE may compare the first metric with the second metric. In particular, the UE may compare a difference between the first metric and the second metric with a threshold. According to the result of comparing the difference between the first metric and the second metric with the threshold, the UE may determine the channel information based on at least one of the first type of reference signals and the second type of reference signals.

In some cases, when the difference is less than the threshold (i.e., the quality of the first type of reference signals may be similar to the quality of the second type of reference signals), the channel information may be determined based on at least one of the first type of reference signals and the second type of reference signals. In other words, when the difference is less than the threshold, the UE may use the first type of reference signals and/or the second type of reference signals for determining the channel information subsequently, which means that the UE may determine the channel information according to compressed sensing-based channel acquisition. In addition, the determined channel information may be used for subsequent communication. For example, when the difference is less than the threshold, the UE uses the first type of reference signals for determining the channel information subsequently.

In some cases, when the difference is equal to or greater than the threshold (i.e., the quality of the first type of reference signals may not be similar to the quality of the second type of reference signals), the channel information may be determined based on the second type of reference signals. In other words, when the difference is equal to or greater than the threshold, the UE may use the second type of reference signals for determining the channel information subsequently, which means that the UE may determine the channel information according to normal reference signal measurements. In addition, the determined channel information may be used for subsequent communication.

According to a result of comparing the first metric with the second metric, the UE may determine channel information based on at least one of the first type of reference signals and the second type of reference signals.

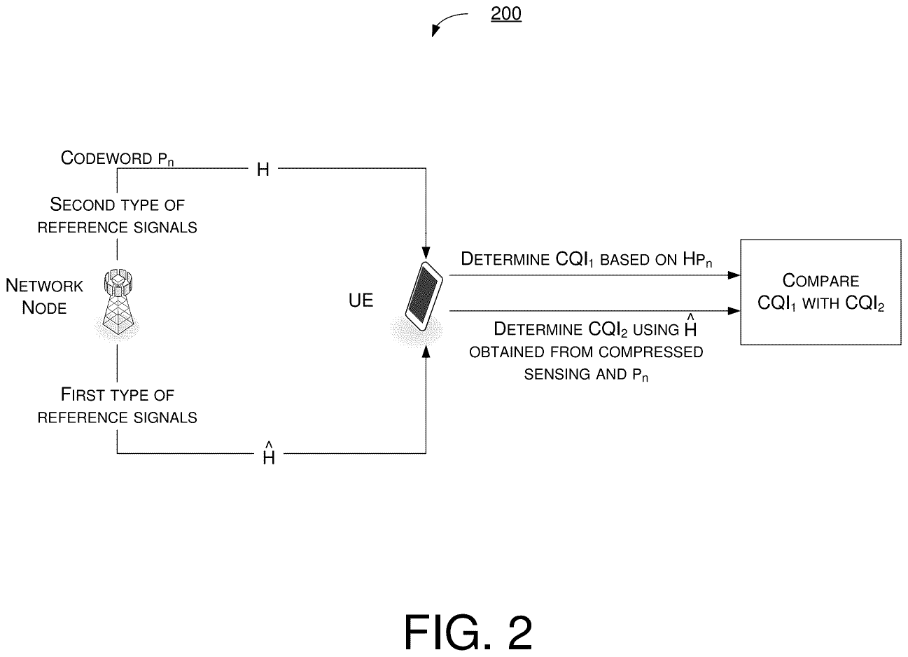

FIG. 2 illustrates an example scenario 200 under schemes in accordance with implementations of the present disclosure. For example, the network node transmits the second type of reference signals to the UE based on codeword Pₙ (i.e, precoder Pₙ) through channel H. After receiving (i.e., measuring) the second type of reference signals, the UE determines CQI₁ based on measured HPₙ. The network node transmits the first type of reference signals to the UE through channel Ĥ. After receiving (i.e., measuring) the first type of reference signals, the UE determines CQI₂ using the channel Ĥ obtained from compressed sensing and the codeword Pₙ (which is preconfigured by the network node). The UE compares CQI₁ and CQI₂.

When the difference between CQI₁ and CQI₂ is less than the threshold, it means that compressed sensing for channel acquisition works satisfactorily. Therefore, the UE uses the first type of reference signals for determining the channel information subsequently.

When the difference between CQI₁ and CQI₂ is equal to or greater than the threshold, it means that compressed sensing for channel acquisition does not work satisfactorily as the normal reference signal measurement. Therefore, the UE uses the second type of reference signals for determining the channel information subsequently. In this case, channel measurements are performed less frequently compared to cases where both types of reference signals are used.

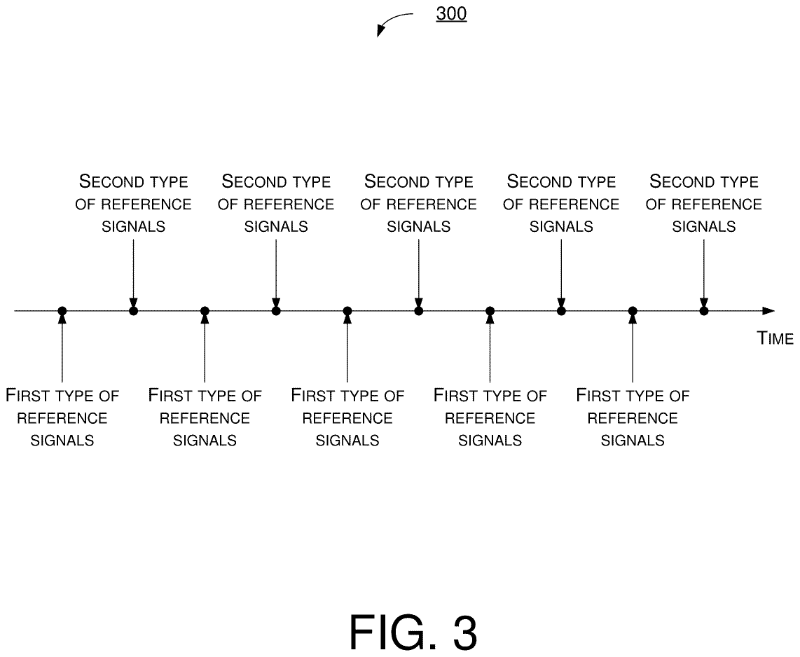

FIG. 3 illustrates an example scenario 300 under schemes in accordance with implementations of the present disclosure. For example, the network node transmits the first type of reference signals and the second type of reference signals alternatively. However, the example is provided for illustrative purposes only and is not intended to limit the scope of the present disclosure. In other examples, the network node may transmit the first type of reference signals periodically within a first period and may transmit the second type of reference signals periodically within another period.

### Illustrative Implementations

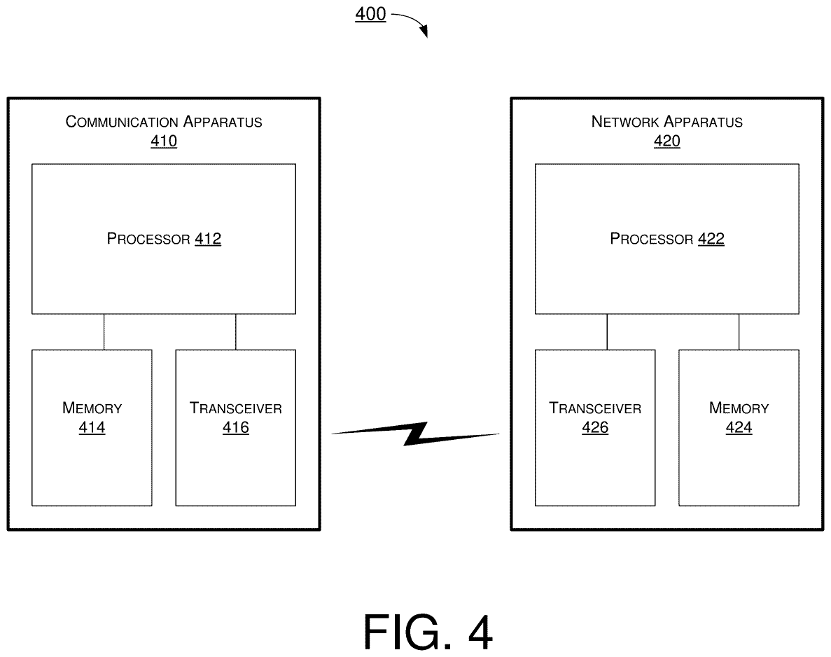

FIG. 4 illustrates an example communication system 400 having an example communication apparatus 410 and an example network apparatus 420 in accordance with an implementation of the present disclosure. Each of communication apparatus 410 and network apparatus 420 may perform various functions to implement schemes, techniques, processes and methods described herein pertaining to determining channel information based on reference signal types with respect to UE and network apparatus in mobile communications, including scenarios/schemes described above as well as processes 500 and 600 described below.

Communication apparatus 410 may be a part of an electronic apparatus, which may be a UE such as a portable or mobile apparatus, a wearable apparatus, a wireless communication apparatus or a computing apparatus. For instance, communication apparatus 410 may be implemented in a smartphone, a smartwatch, a personal digital assistant, a digital camera, or a computing equipment such as a tablet computer, a laptop computer or a notebook computer. Communication apparatus 410 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 410 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 410 may include at least some of those components shown in FIG. 4 such as a processor 412, for example. Communication apparatus 410 may further include one or more other components not pertinent to the proposed scheme of the present disclosure (e.g., internal power supply, display device and/or user interface device), and, thus, such component(s) of communication apparatus 410 are neither shown in FIG. 4 nor described below in the interest of simplicity and brevity.

Network apparatus 420 may be a part of a network apparatus, which may be a network node such as a satellite, a base station, a small cell, a router or a gateway. For instance, network apparatus 420 may be implemented in an eNodeB in an LTE network, in a gNB in a 5G/NR, IoT, NB-IoT or IIoT network or in a satellite or base station in a 6G network. Alternatively, network apparatus 420 may be implemented in the form of one or more IC chips such as, for example and without limitation, one or more single-core processors, one or more multi-core processors, or one or more RISC or CISC processors. Network apparatus 420 may include at least some of those components shown in FIG. 4 such as a processor 422, for example. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including determining channel information based on reference signal types in a device (e.g., as represented by communication apparatus 410) and a network (e.g., as represented by network apparatus 420) in accordance with various implementations of the present disclosure.

In some implementations, communication apparatus 410 may also include a transceiver 416 coupled to processor 412 and capable of wirelessly transmitting and receiving data. In other words, processor 412 may transceive the data such as configuration, message, signal, information, indicator, etc. via transceiver 416. In some implementations, communication apparatus 410 may further include a memory 414 coupled to processor 412 and capable of being accessed by processor 412 and storing data therein. In some implementations, network apparatus 420 may also include a transceiver 426 coupled to processor 422 and capable of wirelessly transmitting and receiving data. In other words, processor 422 may transceive the data such as configuration, message, signal, information, indicator, etc. via transceiver 426. In some implementations, network apparatus 420 may further include a memory 424 coupled to processor 422 and capable of being accessed by processor 422 and storing data therein. Accordingly, communication apparatus 410 and network apparatus 420 may wirelessly communicate with each other via transceiver 416 and transceiver 426, respectively. To aid better understanding, the following description of the operations, functionalities and capabilities of each of communication apparatus 410 and network apparatus 420 is provided in the context of a mobile communication environment in which communication apparatus 410 is implemented in or as a communication apparatus or a UE and network apparatus 420 is implemented in or as a network node of a communication network.

In some implementations, each of memory 414 and memory 424 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 414 and memory 424 may include a type of read-only memory (ROM) such as mask ROM, programmable ROM (PROM), erasable programmable ROM (EPROM) and/or electrically erasable programmable ROM (EEPROM). Alternatively, or additionally, each of memory 414 and memory 424 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

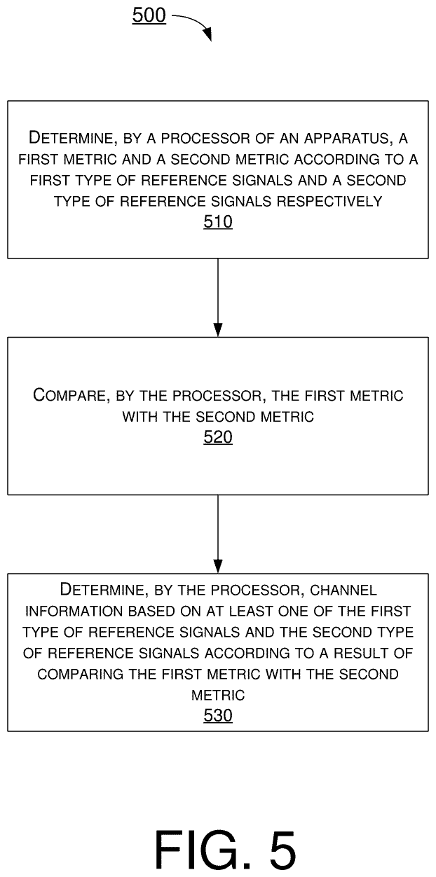

FIG. 5 illustrates an example process 500 in accordance with an implementation of the present disclosure. Process 500 may be an example implementation of above scenarios/schemes, whether partially or completely, with respect to determining channel information based on reference signal types of the present disclosure. Process 500 may represent an aspect of implementation of features of communication apparatus 410. Process 500 may include one or more operations, actions, or functions as illustrated by one or more of blocks 510 to 530. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by communication apparatus 410 or any suitable UE or machine type devices. Solely for illustrative purposes and without limitation, process 500 is described below in the context of communication apparatus 410. Process 500 may begin at block 510.

At block 510, process 500 may involve processor 412 of communication apparatus 410 determining a first metric and a second metric according to a first type of reference signals and a second type of reference signals respectively. Process 500 may proceed from block 510 to block 520.

At block 520, process 500 may involve processor 412 of communication apparatus 410 comparing the first metric with the second metric. Process 500 may proceed from block 520 to block 530.

At block 530, process 500 may involve processor 412 of communication apparatus 410 determining channel information based on at least one of the first type of reference signals and the second type of reference signals according to a result of comparing the first metric with the second metric.

In some implementations, the first metric and the second metric may include CQIs or RSRPs.

In some implementations, process 500 may involve processor 412 of communication apparatus 410 receiving the first type of reference signals and the second type of reference signals.

In some implementations, process 500 may involve processor 412 of communication apparatus 410 comparing a difference between the first metric and the second metric with a threshold.

In some implementations, process 500 may involve processor 412 of communication apparatus 410 determining the channel information based on at least one of the first type of reference signals and the second type of reference signals according to the result of comparing the difference between the first metric and the second metric with the threshold.

In some implementations, the channel information may be determined based on at least one of the first type of reference signals and the second type of reference signals in an event that the difference is less than the threshold.

In some implementations, the channel information may be determined based on the second type of reference signals in an event that the difference is equal to or greater than the threshold.

In some implementations, the first type of reference signals may be associated with compressed sensing, which may be used to derive the channel information by reconstructing sparse channel coefficients from a reduced number of measurements.

In some implementations, the second type of reference signals may be associated with normal reference signal measurement, which may be used to derive the channel information by predetermined orthogonal pilot transmissions over allocated resources.

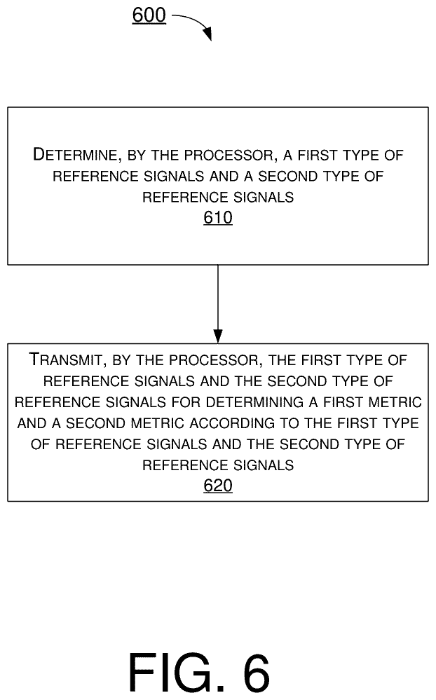

FIG. 6 illustrates an example process 600 in accordance with an implementation of the present disclosure. Process 600 may be an example implementation of above scenarios/schemes, whether partially or completely, with respect to determining channel information based on reference signal types of the present disclosure. Process 600 may represent an aspect of implementation of features of network apparatus 420. Process 600 may include one or more operations, actions, or functions as illustrated by one or more of blocks 610 and 620. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by network apparatus 420 or any suitable network device or machine type devices. Solely for illustrative purposes and without limitation, process 600 is described below in the context of network apparatus 420. Process 600 may begin at block 610.

At block 610, process 600 may involve processor 422 of network apparatus 420 determining a first type of reference signals and a second type of reference signals. Process 600 may proceed from block 610 to block 620.

At block 620, process 600 may involve processor 422 of network apparatus 420 transmitting the first type of reference signals and the second type of reference signals for determining a first metric and a second metric according to the first type of reference signals and the second type of reference signals.

In some implementations, the first metric and the second metric may include CQIs or RSRPs.

In some implementations, the first type of reference signals may be associated with compressed sensing, which may be used to derive channel information by reconstructing sparse channel coefficients from a reduced number of measurements.

In some implementations, the second type of reference signals may be associated with normal reference signal measurement, which may be used to derive channel information by predetermined orthogonal pilot transmissions over allocated resources.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, a first metric and a second metric according to a first type of reference signals and a second type of reference signals respectively;
comparing, by the processor, the first metric with the second metric; and
determining, by the processor, channel information based on at least one of the first type of reference signals and the second type of reference signals according to a result of comparing the first metric with the second metric.

2. The method of claim 1, wherein the first metric and the second metric include Channel Quality Indicators (CQIs) or Reference Signal Received Powers (RSRPs).

3. The method of claim 1, further comprising:
receiving, by the processor, the first type of reference signals and the second type of reference signals.

4. The method of claim 1, wherein the comparing of the first metric with the second metric further comprises:
comparing, by the processor, a difference between the first metric and the second metric with a threshold.

5. The method of claim 4, wherein the determining of the channel information based on at least one of the first type of reference signals and the second type of reference signals according to the result of comparing the first metric with the second metric further comprises:
determining, by the processor, the channel information based on at least one of the first type of reference signals and the second type of reference signals according to the result of comparing the difference between the first metric and the second metric with the threshold.

6. The method of claim 5, wherein the channel information is determined based on at least one of the first type of reference signals and the second type of reference signals in an event that the difference is less than the threshold.

7. The method of claim 5, wherein the channel information is determined based on the second type of reference signals in an event that the difference is equal to or greater than the threshold.

8. The method of claim 1, wherein the first type of reference signals is associated with compressed sensing, which is used to derive the channel information by reconstructing sparse channel coefficients from a reduced number of measurements.

9. The method of claim 1, wherein the second type of reference signals is associated with normal reference signal measurement, which is used to derive the channel information by predetermined orthogonal pilot transmissions over allocated resources.

10. A method, comprising:
determining, by a processor of an apparatus, a first type of reference signals and a second type of reference signals; and
transmitting, by the processor, the first type of reference signals and the second type of reference signals for determining a first metric and a second metric according to the first type of reference signals and the second type of reference signals.

11. The method of claim 10, wherein the first metric and the second metric include Channel Quality Indicators (CQIs) or Reference Signal Received Powers (RSRPs).

12. The method of claim 10, wherein the first type of reference signals is associated with compressed sensing, which is used to derive channel information by reconstructing sparse channel coefficients from a reduced number of measurements.

13. The method of claim 10, wherein the second type of reference signals is associated with normal reference signal measurement, which is used to derive channel information by predetermined orthogonal pilot transmissions over allocated resources.

14. An apparatus, comprising:
a transceiver which, during operation, wirelessly communicates with a wireless network; and
a processor communicatively coupled to the transceiver such that, during operation, the processor performs operations comprising:
determining a first metric and a second metric according to a first type of reference signals and a second type of reference signals respectively;
comparing the first metric with the second metric; and
determining channel information based on at least one of the first type of reference signals and the second type of reference signals according to a result of comparing the first metric with the second metric.

15. The apparatus of claim 14, wherein the first metric and the second metric include Channel Quality Indicators (CQIs) or Reference Signal Received Power (RSRP).

16. The apparatus of claim 14, wherein, during operation, the processor further performs operations comprising:
receiving, via the transceiver, the first type of reference signals and the second type of reference signals.

17. The apparatus of claim 14, wherein, during operation, the processor further performs operations comprising:
comparing, by the processor, a difference between the first metric and the second metric with a threshold.

18. The apparatus of claim 17, wherein, during operation, the processor further performs operations comprising:
determining the channel information based on at least one of the first type of reference signals and the second type of reference signals according to the result of comparing the difference between the first metric and the second metric with the threshold.

19. The apparatus of claim 18, wherein the channel information is determined based on at least one of the first type of reference signals and the second type of reference signals in an event that the difference is less than the threshold.

20. The apparatus of claim 18, wherein the channel information is determined based on the second type of reference signals in an event that the difference is equal to or greater than the threshold.
